(19) United States
(12) Patent Application Publication
(10) Pub. No.: US 2025/0252289 A1
(43) Pub. Date: Aug. 7, 2025

(54) DATA PROCESSING SYSTEM, DATA PROCESSING METHOD, AND ELECTRONIC DEVICE

(71) Applicant: VIA Technologies, Inc., Taipei (TW)

(72) Inventor: Cheng Yu WEN, Taipei (TW)

(21) Appl. No.: 18/673,517

(22) Filed: May 24, 2024

(30) Foreign Application Priority Data
Feb. 2, 2024 (TW) 113104235

(51) Int. Cl. G06N 3/045; G06N 3/08

(52) U.S. Cl. CPC G06N 3/045; G06N 3/08

(57) ABSTRACT

A data processing system, a data processing method, and an electronic device are provided. The data processing system includes a server and an electronic device. The server stores a plurality of neural network models. The electronic device includes a storage device, a communication interface, and a processor. The storage device stores an adapter master model. The processor outputs the adapter master model and input data to the server. The server embeds the adapter master model into each of the plurality of neural network models, inputs the input data to the plurality of neural network models to generate output data by the plurality of neural network models embedded with the adapter master model, and transmits the output data to the electronic device. The present disclosure is capable of effectively optimize large neural network models.

### CROSS-REFERENCE TO RELATED APPLICATIONS

This application claims the priority benefit of Taiwan application serial no. 113104235, filed on Feb. 2, 2024. The entirety of the above-mentioned patent applications are hereby incorporated by reference herein and made a part of this specification.

### TECHNICAL FIELD

The present disclosure relates to a data processing technology, in particular to a data processing system, a data processing method, and an electronic device.

### BACKGROUND

Currently, large neural network models are widely used. However, general-purpose large neural network models cannot effectively satisfy the needs of personalized computations for different users. In particular, general-purpose large neural network model cannot effectively discriminate site-specific, personalized, and customized data. By far, if a general-purpose large neural network model is required to satisfy the personalized computation needs for different users, respective training and weight adjustment would be needed for a plurality of neural network models in the large neural network model, which costs computational data, time, and manpower, and is therefore less practical.

### SUMMARY

The present disclosure provides a data processing system, a data processing method, and an electronic device, which are capable of effectively optimizing large neural network models.

The data processing system of the present disclosure includes a server and an electronic device. The server is configured to store a plurality of neural network models. The electronic device is configured to be connected to the server. The electronic device includes a storage device, a communication interface, and a processor. The storage device is configured to store an adapter master model. The communication interface is configured to connect to the server. The processor is coupled to the storage device and the communication interface, and is configured to output the adapter master model and input data to the server. The server embeds the adapter master model into each of the plurality of neural network models, inputs the input data to the plurality of neural network models to generate output data by the plurality of neural network models embedded with the adapter master model, and transmits the output data to the electronic device.

The data processing method of the present disclosure includes steps of: connecting to a server by an electronic device; outputting, by a processor of the electronic device, an adapter master model and input data to the server; embedding, by the server, the adapter master model into each of a plurality of neural network models; inputting, by the server, the input data to the plurality of neural network models to generate output data by the plurality of neural network models embedded with the adapter master model; and transmitting, by the server, the output data to the electronic device.

The electronic device of the present disclosure includes a storage device, a communication interface, and a processor. The storage device is configured to store an adapter master model. The communication interface is configured to connect to the server. The processor is coupled to the storage device and the communication interface, and is configured to output the adapter master model and input data to the server. The server embeds the adapter master model into each of a plurality of neural network models, inputs the input data to the plurality of neural network models to generate output data by the plurality of neural network models embedded with the adapter master model, and transmits the output data to the electronic device.

Based on the foregoing, the data processing system, the data processing method, and the electronic device of present disclosure are capable of effectively optimizing a large model by embedding the adapter master model into each of a plurality of neural network models in the large model.

In order to make the above features and benefits of the present disclosure easily understandable, embodiments are described and explained below in details with reference to the drawings accompanying the description.

### BRIEF DESCRIPTION OF THE DRAWINGS

FIG. 1 is a schematic diagram of a data processing system according to an embodiment of the present disclosure.

FIG. 2 is a flow chart of a data processing method according to an embodiment of the present disclosure.

FIG. 3 is a schematic diagram of establishing and embedding an adapter master model according to an embodiment of the present disclosure.

FIG. 4 is a flow chart of training the adapter master model according to an embodiment of the present disclosure.

FIG. 5 is a schematic diagram of application of a data processing system according to an embodiment of the present disclosure.

Reference signs: 100, 500: data processing system; 110, 510: electronic device; 111: processor; 112: storage device; 1121: adapter master model; 113: communication interface; 120, 520: server; 121, 521: large model; 1211, 1212: transformer layer; 121_1 to 121_N: neural network model; 301_1 to 301_M: input data; 310: encoding module; 310_1 to 310_M: encoder; 320: control network model; 321: multilayer perceptron; 322: mapping layer; 331, 332, 5121_1 to 5121_4: adapter model; 521_1: image recognition model; 521_2: voice recognition model; 521_3: language recognition model; 521_4: generative model; S210 to S250, S410 to S430: steps.

### DETAILED DESCRIPTION

In order to make the contents of the present disclosure easily understandable, embodiments are described below as examples of practical implementation of the present disclosure. Moreover, as far as possible, elements/members/steps indicated by the same reference signs in the accompanying drawings and the embodiments represent the same or similar components.

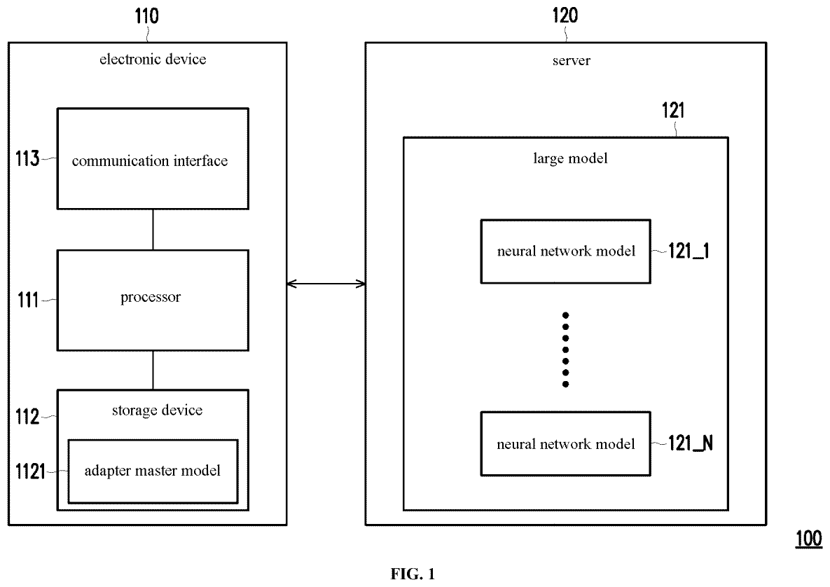

FIG. 1 is a schematic diagram of a data processing system according to an embodiment of the present disclosure. Referring to FIG. 1, the data processing system 100 includes an electronic device 110 and a server 120. The electronic device 110 includes a processor 111, a storage device 112, and a communication interface 113. The processor 111 is coupled to the storage device 112 and the communication interface 113. The storage device 112 is configured to store an adapter master model 1121. In this embodiment, the adapter master model 1121 may include a Low Rank Adapter. In one embodiment, the storage device 112 may store at least one adapter master model and is not limited to that shown in FIG. 1.

In this embodiment, the server 120 may be configured to execute a large model 121. The large model 121 may be, for example, a Chat Generative Pre-trained Transformer (Chat GPT), a Segment Anything Model (SAM), or a Stable Diffusion Model. The large model 121 may include a plurality of neural network models 121_1 to 121_N or other types of network models, where N is a positive integer. It should be noted that the large model 121 in this embodiment may be a general-purpose neural network model. In one embodiment, the neural network models 121_1 to 121_N may be respectively used for different types of input data to generate corresponding output data.

In this embodiment, the electronic device 110 may be, for example, a smart phone, a tablet computer, a laptop computer, or a terminal device or a computer device of such kind. The processor 111 may be, for example, a Central Processing Unit (CPU) or other programmable general-purpose or special-purpose microprocessors, a Digital Signal Processor (DSP), an Image Processing Unit (IPU), a Graphics Processing Unit (GPU), a programmable controller, an Application Specific Integrated Circuit (ASIC), a Programmable Logic Device (PLD), other similar processing devices, or a combination of the above.

In this embodiment, the storage device 112 may be, for example, a Dynamic Random Access Memory (DRAM), a Flash memory, or a Non-Volatile Random Access Memory (NVRAM), etc.

In this embodiment, the communication interface 113 may be a wired or wireless communication interface, such as a cable, a mobile communication interface, a Wi-Fi interface, or Bluetooth, etc. The communication interface 113 is connected to the server 120 to enable communication between the electronic device 110 and the server 120.

In this embodiment, the server 120 may be, for example, a cloud server or may be implemented by a computer device or relevant computer apparatus. The server 120 also includes a processor, a storage device, and a communication interface as described above, and a large model 121 is established within the server 120.

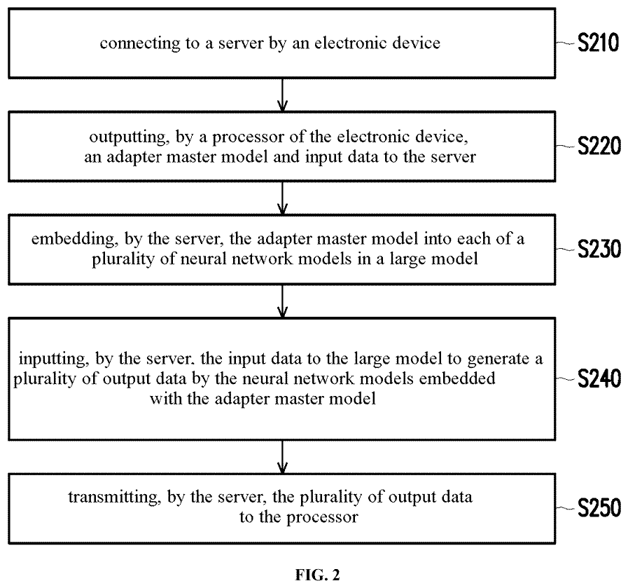

FIG. 2 is a flow chart of a data processing method according to an embodiment of the present disclosure. Referring to FIGS. 1 and 2, the data processing system 100 shown in FIG. 1 may execute the following step S210 to S250. In step S210, the electronic device 110 may be connected to the server 120. In step S220, the processor 111 of the electronic device 110 may output the adapter master model 1121 and the input data to the server 120. The adapter master model 1121 may be established and trained by a user with specific training data.

In step S230, the server 120 may embed the (at least one) adapter master model 1121 into each of the plurality of neural network models 121_1 to 121_N in the large model 121. In one embodiment, the neural network models 121_1 to 121_N may include at least two of an image recognition model, a language recognition model, a voice recognition model, and an (image) generative model. In step S240, the server 120 may input the input data to the large model 120 to generate a plurality of output data through the neural network models 121_1 to 121_N embedded with the adapter master model 1121. In one embodiment, the input data may include at least one of voice input data, language input data, or image input data.

In step S250, the server 120 may transmit the output data to the processor 111 of the electronic device 110. In this embodiment, the adapter master model 1121 may be used to optimize the neural network models 121_1 to 121_N. Each of the neural network models 121_1 to 121_N can achieve an effect of optimized (e.g., personalized) neural network computation by being embedded with the adapter master model 1121.

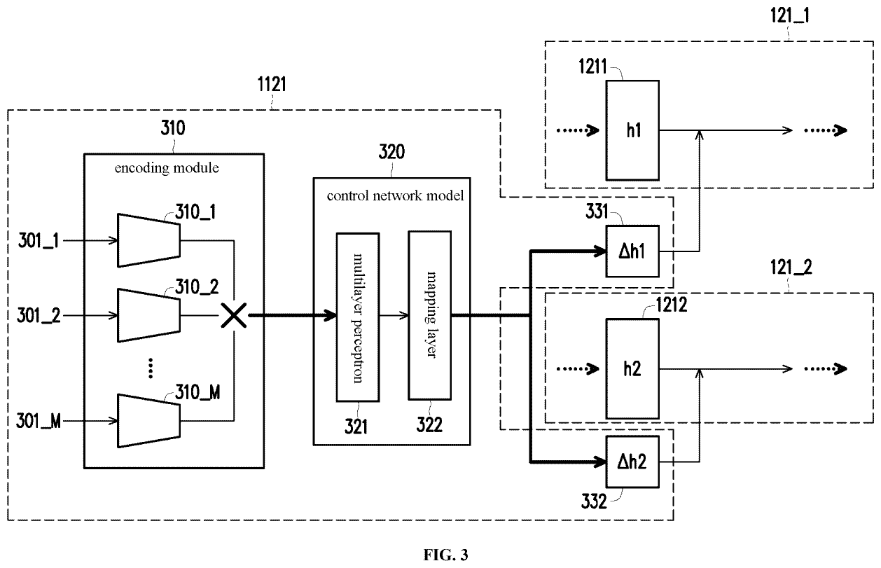

FIG. 3 is a schematic diagram of establishing and embedding an adapter master model according to an embodiment of the present disclosure. In this embodiment, the adapter master model 1121 may include an encoding module 310, a control network model 320, and an adapter model. Here, only two adapter models 331 and 332 are illustrated for the sake of explanation; but the present disclosure is not limited thereto. The number of adapter models may correspond to the number of the neural network models 121_1 to 121_N such that each neural network model has a corresponding adapter model. In this embodiment, the encoding module 310 may include a plurality of encoders 310_1 to 310_M, where M is a positive integer. It should be noted that the encoders 310_1 to 310_M correspond to all possible types of input data that may need to be received by the neural network models 121_1 to 121_N shown in FIG. 1. For example, assuming that the neural network models 121_1 to 121_N include an image recognition model, a language recognition model, a voice recognition model, and a generative model, and that the possible types of input data that may need to be received would include image input data, language input data, and voice input data, then the encoders 310_1 to 310_M may include an image encoder, a language encoder, and a voice encoder.

In this embodiment, the encoders 310_1 to 310_M generate a plurality of feature parameters based on the plurality of input data 301_1 to 301_M. The input data 301_1 to 301_M may include, for example, image input data, language input data, voice input data, and the like. Each of the encoders 310_1 to 310_M may generate 3 feature parameters and form 1×3 or 3×1 matrix data, for example. The encoding module 310 may establish a relation matrix based on these feature parameters. For example, the encoding module 310 may combine a plurality of 1×3 or 3×1 matrix data generated by the encoders 310_1 to 310_M. For example, three 1×3 or 3×1 matrix data may be composed into 3×3×3 matrix data. Subsequently, the encoding module 310 may perform a data level flattening process on the relation matrix to output, for example, 27 feature parameters to the control network model 320. The control network model 320 may select, by the multilayer perceptron (MLP) 321, a part of the plurality of feature parameters in the relation matrix to input to the mapping layer 322. For example the multilayer perceptron 321 may select 18 feature parameters out of 27 feature parameters. The mapping layer 322 may for example further generate inputs provided to the adapter model 331 and the adapter model 332 (and the neural network model 121_1 and the neural network model 121_2) based on the 18 feature parameters. The adapter model 331 may include for example a 3×3×25 weight matrix. The adapter model 332 may include a 3×3×15 weight matrix, for example. The electronic device 110 shown in FIG. 1 may store the adapter model 331 and the adapter model 332. In other embodiments, the inputs provided to the neural network models and the adapter models may also be generated using other structures of encoding module and control network model.

In this embodiment, taking the neural network models 121_1 and 121_2 shown in FIG. 1 as an example, the neural network models 121_1 and 121_2 may be, for example, an image recognition model and a language recognition model, respectively; each may include multiple dense layers for executing matrix multiplication; a dense layer is such a layer where each neuron is connected with each neuron of a previous layer; and the weight matrix in these layers is usually of full-rank. The adapter model 331 and the adapter model 332 may be respectively configured to be embedded into the respective transformer layers 1211, 1212 of the neural network models 121_1 and 121_2. The transformer layers 1211, 1212 may each be a certain layer of the neural network models 121_1, 121_2. The adapter model 331 and the adapter model 332 may each be embedded into a Multi-Head Attention Layer or a Feed Forward Layer in the transformer layer, but the present disclosure is not limited thereto. For the ease of explanation, FIG. 3 only illustrates the transformer layers 1211 and 1212 of the neural network models 121_1 and 121_2 and does not illustrate the neural network layers for other functions. Although this embodiment describes an example where the adapter model is embedded into the transformer layer, the adapter model may also be embedded into another type of dense layer in other embodiments.

In this embodiment, the server may combine the weight matrix (Δh1) of the adapter model 331 with the original weight matrix (h1) of the transformer layer 1211 of the neural network model 121_1 (h1′=h1+Δh1) to generate the output of the transformer layer 1211. The server may combine the weight matrix (Δh2) of the adapter model 332 with the original weight matrix (h2) of the transformer layer 1212 of the neural network model 121_2 (h2′=h2+Δh2) to generate the output of the transformer layer 1212. Moreover, the numbers of parameters of the weight matrices of the adapter model 331 and the adapter model 332 are both far less than the numbers of parameters of the original weight matrices of the transformer layer 1211 of the neural network models 121_1 and the transformer layer 1212 of the neural network model 121_2. In one embodiment, if the original weight matrix (h1) of the transformer layer 1211 is a p×q matrix, the weight matrix (Δh1) of the adapter model 331 may be designed as the matrix multiplication of a first matrix A and a second matrix B (i.e., Δh1=AB), with the first matrix A being a p×r matrix and the second matrix B being a r×q matrix, and r<<min (p, q). The adapter model 332 may be designed in a similar way. As such, the weight matrix (Δh1) of the adapter model 331 and the original weight matrix (h1) of the transformer layer 1211 both have the dimension of p×q, while the number of parameters of the weight matrix of the adapter model 331 is far less than the number of parameters of the original weight matrix of the transformer layer 1211. However, the present disclosure is not limited thereto; one skilled in the art may use another method for matrix decomposition or parameter number reduction. In other words, according to this embodiment, in case of the original weight matrix (h1) of the transformer layer 1211 of the neural network models 121_1 and the original weight matrix (h2) of the transformer layer 1212 of the neural network models 121_2 being unchanged, the neural network models 121_1 and 121_2 can be optimized (or personalized) through the weight matrix (Δh1) of the adapter model 331 and the weight matrix (Δh2) of the adapter model 332 which have a smaller number of parameters.

Furthermore, the optimization for the neural network models 121_3 to 121_N is the same with the optimization for the neural network models 121_1 and 121_2, and thus is not repeated here.

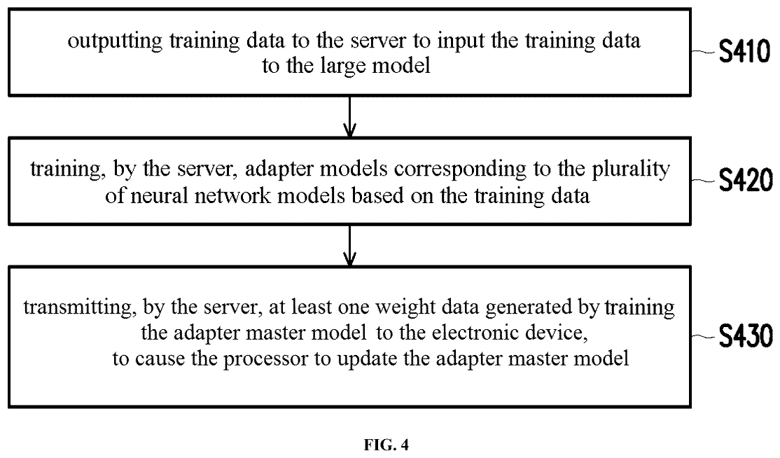

FIG. 4 is a flow chart of training the adapter master model according to an embodiment of the present disclosure. Referring to FIGS. 1 and 4, after the above adapter master model is established and embedded into a certain neural network model, the data processing system may also carry out the following steps S410 to S430 to train the adapter master model. In step S410, the electronic device 110 may first output training data to the server 120 to input the training data to the large model 121 and the adapter master model 1121. The training data may be specific data for optimizing (or personalizing) the neural network model, for example. In step S420, based on the training data, the server 120 may train the encoding module 310, the control network model 320, and/or the adapter models corresponding to respective neural network models 121_1 to 121_N in the adapter master model 1121. The training data may be determined according to the needs of the user and may be configured to train the adapter master model 1121, so that each of the neural network models 121_1 to 121_N embedded with the adapter master model 1121 may have the neural network computation capability meeting the needs of the user. In one embodiment, upon training the adapter master model 1121, the original weight matrices of respective transformer layers of the neural network models 121_1 to 121_N remain unchanged, and only the weight matrices of the corresponding adapter models are trained.

In this embodiment, the server 120 may train the adapter master model 1121 based on a loss function. The loss function may be the result of a sum of products of multiplying a plurality of sub-loss functions (e.g., a plurality of sub-loss functions represented by L_1, L_2 to L_N) output by respective neural network models 121_1 to 121_N embedded with the adapter master model 1121 by a plurality of corresponding coefficients (e.g., a plurality of coefficients represented by a_1, a_2 to a_N) (e.g., the total loss function L=(a_1)×(L_1)+ (a_2)×(L_2)+ . . . + (a_N)×(L_N)), and a sum of the coefficients is 1 (e.g., (a_1)+ (a_2)+ . . . + (a_N)=1). The server 120 may for example determine whether or not optimization on the adapter master model 1121 is completed according to whether or not the total loss function L has a minimum value. In one embodiment, by setting the coefficients a_1 to a_N, relative importance of optimization on the corresponding neural network models 121_1 to 121_N may be adjusted; for example, if an optimization on the neural network model 121_1 is relatively important, the corresponding coefficient a_1 may be set to a greater value.

In step S430, the server 120 may transmit at least one weight data generated by training the adapter master model 1121 to the electronic device 110 to cause the processor 111 to update the adapter master model 1121. In one embodiment, the weight data generated by training the adapter master model 1121 may include the weight data for the encoding module 310, the weight data for the control network model 320, and/or the weight data for the adapter models corresponding to the respective neural network models 121_1 to 121_N. Therefore, the data processing system is capable of effectively training the adapter master model 1121 and storing the trained adapter master model 1121 in the electronic device 110. When a user intends to use the large model 121 or another large model, the user may operate the electronic device 110 to output the above trained adapter master model 1121 to the server 120 or another computing apparatus carrying another large model, so as to embed the adapter master model 1121 into the large model 121 or another large model. As such, it is possible to optimize or personalize the large model 121 or another large model quickly and effectively.

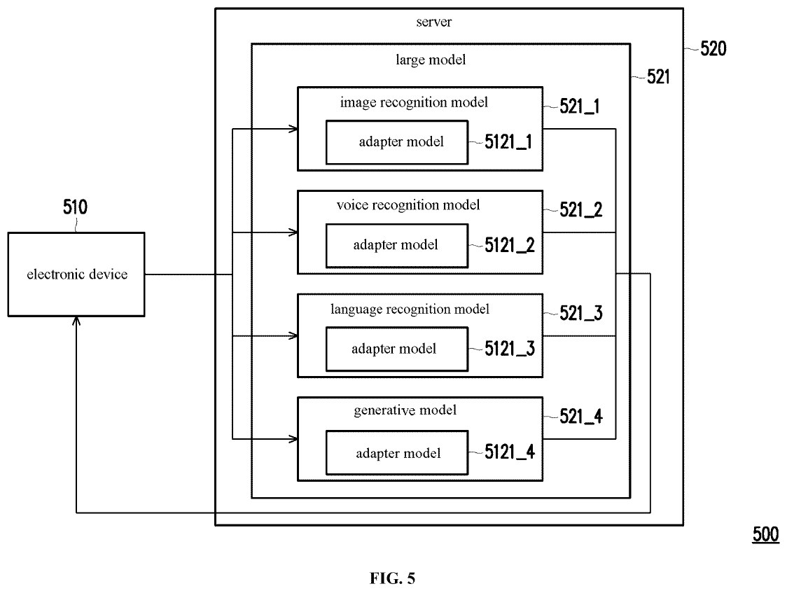

FIG. 5 is a schematic diagram of application of a data processing system according to an embodiment of the present disclosure. Referring to FIG. 5, the data processing system 500 includes an electronic device 510 and a server 520. In this embodiment, an example is described in which the plurality of neural network models are respectively an image recognition model 521_1, a voice recognition model 521_2, a language recognition model 521_3, and a generative model 521_4. In this embodiment, the electronic device 510 stores an adapter master model (not illustrated) including adapter models 5121_1 to 5121_4; and the adapter master model may be established and trained by the method described in the embodiments in FIGS. 1 to 4. In this embodiment, the user may operate the electronic device 510 to output (at least one) adapter master model to the server 520 to cause the server 520 to embed the adapter master model into each of the image recognition model 521_1, the voice recognition model 521_2, the language recognition model 521_3, and the generation model 521_4 in the large model 521. Accordingly, each of the image recognition model 521_1, the voice recognition model 521_2, the language recognition model 521_3, and the generation model 521_4 is embedded with a corresponding adapter model 5121_1 to 5121_4.

Next, the user may operate the electronic device 510 to output input data to the server 520. The input data is, for example, voice data of “Please draw a portrait for me”. The server 520 may input the voice data of “Please draw a portrait for me” to the voice recognition model 521_2 embedded with the adapter model 5121_2 to cause the voice recognition model 521_2 to generate output data that may be, for example, “the user is Xiaoming Wang, and the user is about 8 years old”. Then, the output data generated by the voice recognition model 521_2 may be used as the input data to the language recognition model 521_3 and input to the language recognition model 521_3 embedded with the adapter model 5121_3 to cause the language recognition model 521_3 to generate output data that may be, for example, “draw a portrait of Xiaoming Wang”. Subsequently, the output data generated by the voice recognition model 521_2 and the language recognition model 521_3 may be used as the input data to the generative model 521_4 and input to the generative model 521_4 embedded with the adapter model 5121_4 to cause the generative model 521_4 to generate output data that may be, for example, image data of a portrait of Xiaoming Wang. Moreover, since the input data provided by the user in this example does not include image data, the server 520 may automatically cause a zero matrix to be input to the image recognition model 521_1.

It should be noted that the large model 521 is a general-purpose neural network model. Without being embedded with an adapter master model, the non-personalized large model 521 may not be able to effectively recognize that the user is Xiaoming Wang and the voice thereof, and also not be able to effectively generate the image data of the portrait of Xiaoming Wang. In this regard, the adapter master model may be trained by the method described in the embodiments in FIGS. 1 to 4 to enable the neural network model embedded with the adapter master model to achieve the effect of a personalized neural network computation. In addition, since the existing parameter data of the large model 521 is unchanged, the embodiment enables a quick personalized optimization of the large model 521.

Furthermore, in this embodiment, in response to the processor of the electronic device 510 receiving an operation instruction input by a user (e.g., an instruction of ending the use of the large model 521), the processor of the electronic device 510 can notify the server 520 according to the operation instruction to cause the server 520 to remove the adapter master model embedded into each of the image recognition model 521_1, the voice recognition model 521_2, the language recognition model 521_3, and the generative model 521_4. As such, the personalized customized weight is retained only at the local end (i.e., the electronic device 510), thereby effectively ensuring data safety and privacy.

As described above, the data processing system, the data processing method, and the electronic device of the present disclosure may establish and train an adapter master model according to personalized optimization needs, and embed this adapter master model into each of a plurality of neural network models in a large model, to optimize the large model quickly and effectively.

The above only describes preferred embodiments of the present disclosure, but is not intended to define the scope of the present disclosure. Anyone skilled in the art can make further improvements and changes on this basis without departing from the spirit and scope of the present disclosure. Therefore, the scope of protection of the present disclosure shall be based on the scope defined by the claims of the present application.

What is claimed is:

1. A data processing system, comprising:
a server configured to store a plurality of neural network models; and
an electronic device configured to be connected to the server, comprising:
a storage device configured to store an adapter master model;
a communication interface configured to connect to the server; and
a processor coupled to the storage device and the communication interface, and configured to output the adapter master model and input data to the server,
wherein the server embeds the adapter master model into each of the plurality of neural network models, inputs the input data to the plurality of neural network models to generate output data by the plurality of neural network models embedded with the adapter master model, and transmits the output data to the electronic device.

2. The data processing system according to claim 1, wherein the adapter master model comprises a plurality of adapter models, each adapter model of the plurality of adapter models comprises a weight matrix, and the server combines the weight matrix of each adapter model with an original weight matrix of a dense layer of a neural network model of the plurality of neural network models corresponding to the adapter model.

3. The data processing system according to claim 2, wherein a number of parameters of the weight matrix is smaller than a number of parameters of the original weight matrix, and a dimension of the weight matrix is the same as a dimension of the original weight matrix.

4. The data processing system according to claim 2, wherein the adapter master model further comprises an encoding module,
wherein the encoding module comprises a plurality of encoders, the plurality of encoders generate a plurality of feature parameters based on the input data, and the encoding module establishes a relation matrix based on the plurality of feature parameters, wherein inputs to the plurality of adapter models are generated based on the relation matrix.

5. The data processing system according to claim 2, wherein the electronic device outputs training data to the server in advance, to input the training data to the plurality of neural network models embedded with the adapter master model,
wherein the server trains the plurality of adapter models corresponding to the plurality of neural network models based on the training data, and the server transmits at least one weight data generated by training the plurality of adapter models to the electronic device to cause the processor to update the adapter master model.

6. The data processing system according to claim 5, wherein when the server is training the plurality of adapter models, the original weight matrices of the plurality of neural network models remain unchanged.

7. The data processing system according to claim 5, wherein the server trains the plurality of adapter models based on a loss function,
wherein the loss function is a result of a sum of products of multiplying a plurality of sub-loss functions output by respective neural network models of the plurality of neural network models embedded with the adapter master model by a plurality of corresponding coefficients, and a sum of the plurality of coefficients equals 1.

8. The data processing system according to claim 1, wherein, in response to the processor receiving an operation instruction, the processor notifies the server according to the operation instruction to remove the adapter master model.

9. A data processing method, comprising:
connecting to a server by an electronic device;
outputting, by a processor of the electronic device, an adapter master model and input data to the server;
embedding, by the server, the adapter master model into each of a plurality of neural network models;
inputting, by the server, the input data to the plurality of neural network models to generate output data by the plurality of neural network models embedded with the adapter master model; and
transmitting, by the server, the output data to the electronic device.

10. The data processing method according to claim 9, wherein the adapter master model comprises a plurality of adapter models, each adapter model of the plurality of adapter models comprises a weight matrix, and the server combines the weight matrix of each adapter model with an original weight matrix of a dense layer of a neural network model of the plurality of neural network models corresponding to the adapter model.

11. The data processing method according to claim 10, wherein a number of parameters of the weight matrix is smaller than a number of parameters of the original weight matrix, and a dimension of the weight matrix is the same as a dimension of the original weight matrix.

12. The data processing method according to claim 10, further comprising:
receiving the input data by an encoding module; and
generating a plurality of feature parameters based on the input data by a plurality of encoders of the encoding module, and establishing a relation matrix based on the plurality of feature parameters;
wherein inputs to the plurality of adapter models are generated based on the relation matrix.

13. The data processing method according to claim 10, further comprising:
outputting in advance, by the electronic device, training data to the server, to input the training data to the plurality of neural network models embedded with the adapter master model;
training the plurality of adapter models corresponding to the plurality of neural network models based on the training data; and
transmitting, by the server, at least one weight data generated by training the plurality of adapter models to the electronic device to cause the processor to update the adapter master model.

14. The data processing method according to claim 13, wherein, when training the plurality of adapter models, the original weight matrices of the plurality of neural network models remain unchanged.

15. The data processing method according to claim 13, further comprising:
training, by the server, the plurality of adapter models based on a loss function,
wherein the loss function is a result of a sum of products of multiplying a plurality of sub-loss functions output by respective neural network models of the plurality of neural network models embedded with the adapter master model by a plurality of corresponding coefficients, and a sum of the plurality of coefficients equals 1.

16. The data processing method according to claim 9, further comprising:
in response to the processor receiving an operation instruction, notifying, by the processor, the server according to the operation instruction to remove the adapter master model.

17. An electronic device, comprising:
a storage device configured to store an adapter master model;
a communication interface configured to connect to a server; and
a processor coupled to the storage device and the communication interface, and configured to output the adapter master model and input data to the server,
wherein the server embeds the adapter master model into each of a plurality of neural network models, inputs the input data to the plurality of neural network models to generate output data by the plurality of neural network models embedded with the adapter master model, and transmits the output data to the electronic device.

18. The electronic device according to claim 17, wherein the adapter master model comprises a plurality of adapter models, each adapter model of the plurality of adapter models comprises a weight matrix, and the server combines the weight matrix of each adapter model with an original weight matrix of a dense layer of a neural network model of the plurality of neural network models corresponding to the adapter model.

19. The electronic device according to claim 18, wherein the electronic device outputs training data to the server in advance, to input the training data to the plurality of neural network models embedded with the adapter master model,
wherein the server trains the plurality of adapter models corresponding to the plurality of neural network models based on the training data, and the server transmits at least one weight data generated by training the plurality of adapter models to the electronic device to cause the processor to update the adapter master model.

20. The electronic device according to claim 17, wherein, in response to the processor receiving an operation instruction, the processor notifies the server according to the operation instruction to remove the adapter master model.
